(19) United States
(12) Patent Application Publication
(10) Pub. No.: US 2026/0021018 A1
(43) Pub. Date: Jan. 22, 2026

(54) NEEDLE COVER RETURN METHOD, NEEDLE COVER PLACEMENT AND REMOVAL SYSTEM AND ADJUSTING DEVICE

(71) Applicant: InnoLux Corporation, Miao-Li County (TW)

(72) Inventors: Shao-Yu CHIU, Miao-Li County (TW); Huang-Ren YAO, Miao-Li County (TW); Wan-Ling LIN, Miao-Li County (TW)

(21) Appl. No.: 19/244,230

(22) Filed: Jun. 20, 2025

Related U.S. Application Data
(60) Provisional application No. 63/673,394, filed on Jul. 19, 2024.

(30) Foreign Application Priority Data
Mar. 20, 2025 (CN) 202510334630.0

(51) Int. Cl. A61M 5/32; B25J 11/00

(52) U.S. Cl. CPC A61J 1/20; B25J 11/00

(57) ABSTRACT

A cover return method is provided for a syringe, and includes: providing the syringe, wherein the syringe is fixed on a first clamping element and has a needle head; providing a needle cover, wherein the needle cover is fixed on a second clamping element and has an accommodating space; providing an adjusting element, wherein, when the first clamping element and the second clamping element are close to each other so that the needle head is adjacent to the needle cover, the adjusting element adjusts an extension direction of the needle head to be toward an extension direction of the accommodating space; and the first clamping element and the second clamping element continuing to be close to each other so that the needle head is inserted into the accommodating space of the needle cover.

### CROSS-REFERENCE TO RELATED APPLICATIONS

This application claims the benefit of filing date of U.S. Provisional Application Ser. No. 63/673,394 filed on Jul. 19, 2024 under 35 USC § 119(e)(1), and also claims the benefit of the Chinese Patent Application Serial Number 202510334630.0, filed on Mar. 20, 2025, the subject matters of which are incorporated herein by reference.

### BACKGROUND

### Field of the Application

The present application relates to a needle cover return method, a needle cover placement and removal system and an adjusting device, and more particularly, to a needle cover return method, a needle cover placement and removal system and an adjusting device for a syringe.

### Description of Related Art

In current automated equipment, although a machine (such as a robotic arm) can be used to clamp the syringe to perform the needle cover placement and removal, if the needle head of the syringe becomes skewed after use (such as extracting liquid or injecting), the skewed needle head may pierce the transparent needle cover when returning the needle cover to the syringe, or the needle head may leak out, causing the residual solution in the syringe to easily overflow, which will cause environmental pollution or affect the safety of the syringe operator (for example, medical staff). If the spilled solution is toxic, it will affect the surrounding environment and even become a public safety issue. Furthermore, the skewed needle head will also cause the needle cover to be placed in a screwed manner, resulting in deviation in the clamping of the syringe, or even causing clamping failure.

Therefore, it is desired to provide a novel needle cover return method, needle cover placement and removal system and adjusting device to alleviate and/or obviate the aforementioned problems.

### SUMMARY

The present application provides a needle cover return method for a syringe, which includes: providing the syringe, wherein the syringe is fixed on a first clamping element and has a needle head; providing a needle cover, wherein the needle cover is fixed on a second clamping element and has an accommodating space; providing an adjusting element, wherein, when the first clamping element and the second clamping element are close to each other so that the needle head is adjacent to the needle cover, the adjusting element is provided to adjust an extension direction of the needle head to be toward an extension direction of the accommodating space; and the first clamping element and the second clamping element continuing to be close to each other so that the needle head is inserted into the accommodating space of the needle cover.

The present application further provides a needle cover placement and removal system for returning a needle cover to a syringe, which includes: a first clamping element for fixing the syringe, wherein the syringe has a needle head; a second clamping element for fixing the needle cover, wherein the needle cover has an accommodating space; and an adjusting element, wherein, when the first clamping element and the second clamping element continue to be close to each other, the adjusting element is provided to adjust an extension direction of the needle head toward an extension direction of the accommodating space.

The present application further provides an adjusting device for adjusting a needle head of a syringe, which includes: a first adjusting unit; and a second adjusting unit, wherein at least one of the first adjusting unit and the second adjusting unit has an opening, and a shape of the opening is a triangle in a top-view direction.

Other novel features of the application will become more apparent from the following detailed description when taken in conjunction with the accompanying drawings.

### BRIEF DESCRIPTION OF DRAWINGS

FIG. 1 is an exploded view of a needle cover placement and removal device for a syringe according to an embodiment of the present application;

FIG. 2A is a flowchart illustrating the steps of drug dispensing process of a drug dispensing device using a syringe according to an embodiment of the present application;

FIG. 2B is a flowchart illustrating the steps of the drug dispensing

process of the drug dispensing device according to another embodiment of the present application;

FIG. 3A is a flowchart illustrating the steps of cover return performed by a needle cover placement and removal system according to an embodiment of the present application;

FIG. 3B is a flowchart illustrating the steps of cover removal by the needle cover placement and removal system according to an embodiment of the present application;

FIG. 4 is a schematic diagram of the needle cover placement and removal system performing cover return according to an embodiment of the present application;

FIG. 5 is another schematic diagram of the needle cover placement and removal system according to an embodiment of the present application;

FIG. 6A is a side view of an adjusting device according to an embodiment of the present application;

FIG. 6B is a top view of an adjusting device according to an embodiment of the present application;

FIG. 6C is another top view of the adjusting device according to an embodiment of the present application;

FIG. 6D is a top view of the adjusting device according to another embodiment of the present application;

FIG. 7 shows the operation process of the adjusting device;

FIG. 8 is another schematic diagram of the needle cover placement and removal system according to an embodiment of the present application;

FIG. 9A is an exploded view of a needle cover placement and removal device for a syringe according to another embodiment of the present application;

FIG. 9B shows the needle cover placement and removal device for a syringe according to another embodiment of the present application in a state where the cover clamping element is open;

FIG. 10 is a usage status diagram of a needle cover placement and removal device for a syringe according to another embodiment of the present application;

FIG. 11A is a perspective view of the needle cover placement and removal device for a syringe according to another embodiment of the present application;

FIG. 11B is an exploded view of a clamping device for a syringe according to another embodiment of the present application;

FIG. 12A is an enlarged view of the first area L in FIG. 10; and

FIG. 12B is an enlarged view of the second area K in FIG. 10.

### DETAILED DESCRIPTION OF EMBODIMENT

Different embodiments of the present application are provided in the following description. These embodiments are meant to explain the technical content of the present application, but not meant to limit the scope of the present application. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims, such as “electrically connect” and “couple”, are intended that an element may not only directly electrically connect to other element, but also indirectly electrically connect to other element.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

In addition, the adjusting device disclosed in the present application may be applied to the electronic device itself or the application of the electronic device. The electronic device may include automation equipment, clamping device, mobile platform picking device, computing device, mechanical equipment, drug dispensing device, exposure device, printing device, three-dimensional printing device, automotive device, imaging device, assembly device, backlight device, antenna device, tiled device, touch electronic device, curved electronic device or free shape electronic device, but not limited thereto. The display device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may include, for example, a display tiled device or an antenna tiled device, but not limited thereto. It should be noted that the electronic device may be any arrangement or combination of the aforementioned, but not limited thereto. In addition, the electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have a peripheral system such as a driving system, a control system, a light source system, a shelf system, etc. to support a display device, an antenna device, or a tiled device. The electronic device may include, for example, electronic components, liquid crystal, light emitting diode, quantum dot (QD), fluorescence, phosphor, other suitable display media, or a combination of the above materials, but not limited thereto. The electronic components may include passive components and active components, such as capacitors, resistors, inductors, diodes, transistors, etc. The diode may include a light emitting diode or a photodiode. The light emitting diode may include, for example, an organic light emitting diode (OLED), a sub-millimeter light emitting diode (mini LED), a micro light emitting diode (micro LED) or a quantum dot light emitting diode (quantum dot LED, including QLED, QDLED), a light emitting diode of a flexible display, or other suitable materials, or a combination thereof, but not limited thereto.

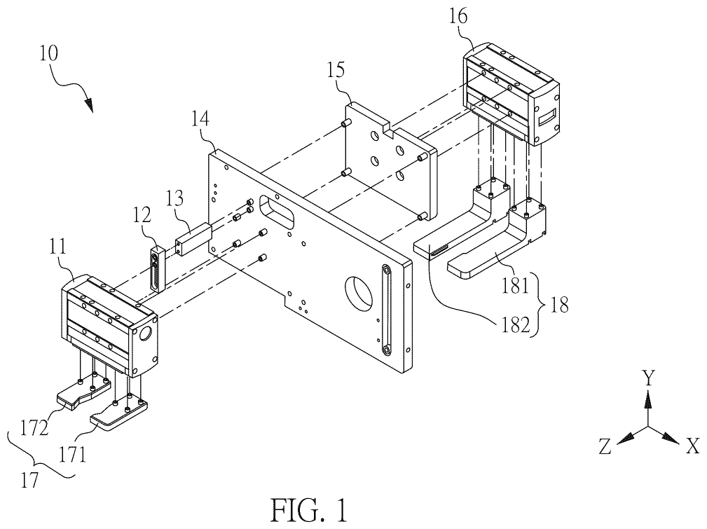

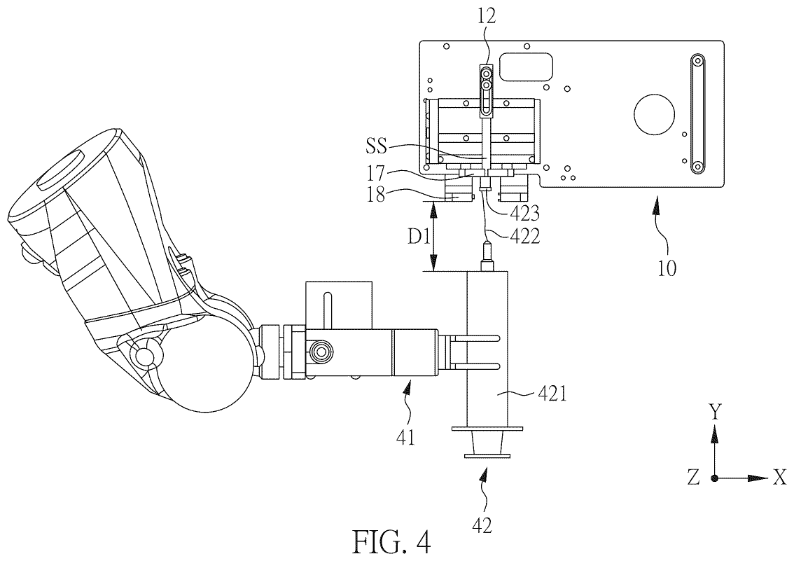

Please refer to FIG. 1 which shows an exploded view of a needle cover placement and removal device 10 for a syringe according to an embodiment of the present application. The needle cover replacement and removal device 10 includes a first driving unit 11, a base plate 14, a first fixing member 15, a second driving unit 16, a second clamping element 17 and an adjusting element 18, wherein the first driving unit 11 may be fixed on the base plate 14, and the second clamping element 17 has a first clamping unit 171 and a second clamping unit 172, which are correspondingly arranged and arranged below the first driving unit 11, so that the first driving unit 11 may control the second clamping element 17 to move along the X direction, causing the first clamping unit 171 and the second clamping unit 172 to be close to or away from each other, thereby performing an operation of clamping the needle cover 423 (shown in FIG. 4). The second driving unit 16 may be fixed on the base plate 14 through the first fixing member 15. The adjusting element 18 has a first adjusting unit 181 and a second adjusting unit 182, which are correspondingly arranged and arranged below the second driving unit 16, so that the second driving unit 16 may control the adjusting element 18 to move along the X direction, causing the first adjusting unit 181 and the second adjusting unit 181 to be close to or away from each other, thereby performing an operation of adjusting the needle head 422 (shown in FIG. 4). In addition, the needle cover placement and removal device 10 may further include a limiting element 12 and a second fixing member 13. The limiting element 12 may be fixed to the base plate 14 through the second fixing member 13. The first fixing member 13, the base plate 14 and the second fixing member 15 may be provided to combine the first driving unit 11, the limiting element 12 and the second driving unit 16 together, and a limiting function may be provided to the clamped needle cover 423 (shown in FIG. 4) by adjusting the height of the limiting element 12.

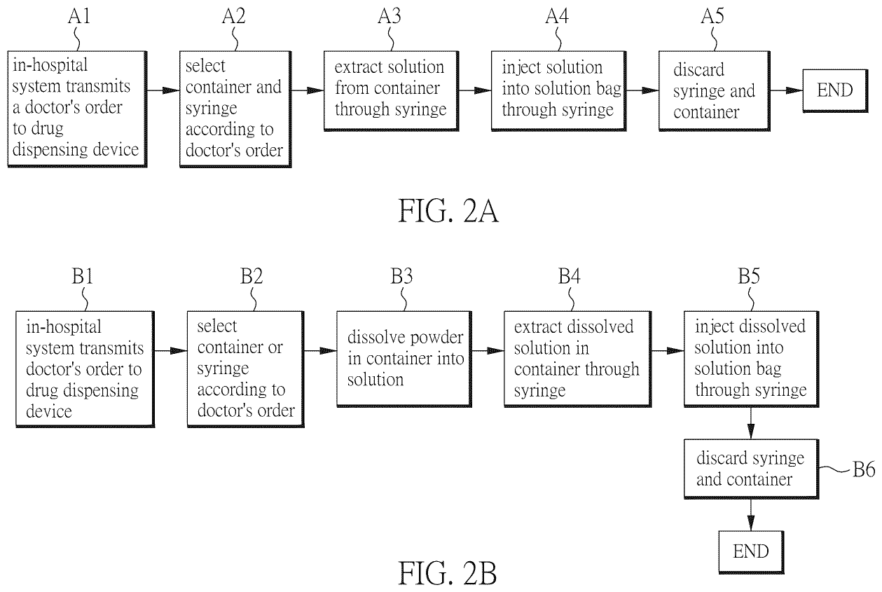

FIG. 2A is a flowchart illustrating the steps of drug dispensing process of a drug dispensing device using a syringe according to an embodiment of the present application, and please refer to FIG. 1 at the same time. As shown, at first, step A1 is executed, in which the in-hospital system transmits a doctor's order (for example, a prescription) to a drug dispensing device. Then, step A2 is executed to select appropriate container and syringe according to the doctor's order. Then, step A3 is executed to extract solution from the container through the syringe. Then, step A4 is executed to inject the solution into a solution bag through the syringe. Then, step A5 is executed to discard the syringe and container. In the above steps, the needle cover placement and removal device 10 may be used in at least one of steps A3 and A5. For example, the needle cover placement and removal device 10 may be used to perform cover removal or cover return in at least one of steps A3 and A5 to facilitate the process, while it is not limited thereto.

FIG. 2B is a flowchart illustrating the steps of the drug dispensing process of the drug dispensing device according to another embodiment of the present application, and please refer to FIG. 1 at the same time. As shown, at first, step B1 is executed, in which the in-hospital system transmits a doctor's order (for example, a prescription) to a drug dispensing device. Then, step B2 is executed to select appropriate container and syringe according to the doctor's order, wherein the container may contain a specific powder. Then, step B3 is executed to dissolve the powder in the container into a solution. Then, step B4 is executed to extract the dissolved solution in the container through the syringe. Then, step B5 is executed to inject the dissolved solution into the solution bag through the syringe. Then, step B6 is executed to discard the syringe and container. In the above steps, the needle cover placement and removal device 10 may be used in at least one of steps B4 and B6. For example, the needle cover placement and removal device 10 may be used to perform cover removal or cover return in at least one of steps B4 and B6 to facilitate the process, while it is not limited thereto.

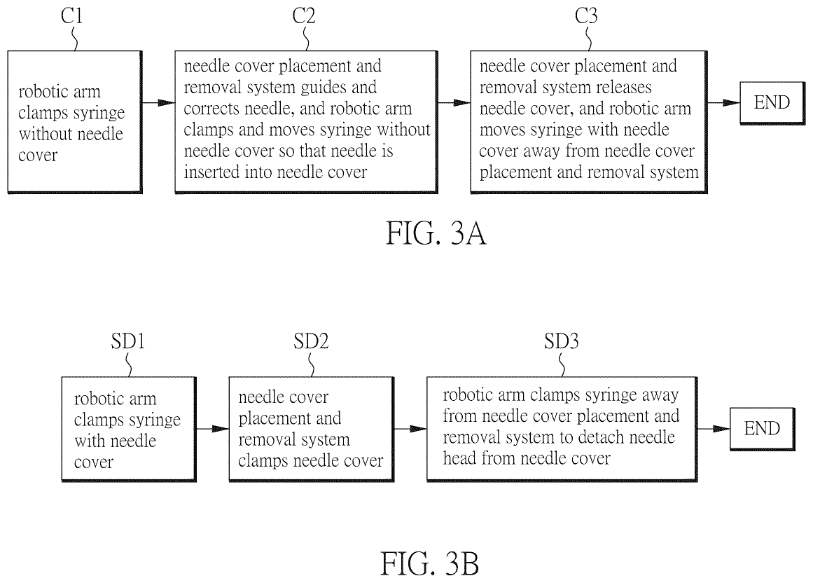

Next, the use of the needle cover placement and removal device 10 in the aforementioned step A5 or step B6 is described. FIG. 3A is a flowchart illustrating the steps of needle cover return (hereinafter referred to as cover return) performed by a needle cover placement and removal system according to an embodiment of the present application, and please refer to FIG. 4 for a schematic diagram of the needle cover placement and removal system performing cover return according to an embodiment of the present application, wherein the needle cover placement and removal system includes a first clamping element 41 and the needle cover placement and removal device 10 as shown in FIG. 1. The first clamping element 41 is, for example but not limited to, a robotic arm, and the first clamping element 41 is suitable for fixing a syringe 42 and the syringe 42 has a needle head 422. The second clamping element 17 of the needle cover placement and removal device 10 is suitable for fixing a needle cover 423, and the needle cover 423 has an accommodating space SS for accommodating the needle head 422 of the syringe 42. The extension direction (Y direction) of the accommodating space SS of the needle cover 423 is parallel to the extension direction (Y direction) of the needle head 422, and the limiting element 12 of the needle cover placement and removal device 10 is suitable for contacting the needle cover 423 to provide a limiting function for the needle cover 423. At first, step C1 is executed, in which the first clamping element 41 clamps the syringe 42 without a needle cover, wherein this step includes first providing a syringe 42, which is fixed on the first clamping element 41 and has a needle head 422, and then providing a needle cover 423, which may be pre-fixed on the second clamping element 17 and has an accommodating space SS. Since the used syringe 42 must be performed with cover return before being discarded, the first clamping element 41 that has clamped the syringe 42 without a needle cover may be controlled to move in the +Y direction and stop at a position where the distance between the upper edge of the barrel 421 of the syringe 42 and the adjusting element 18 is equal to D1. At this moment, the needle head 422 is skewed.

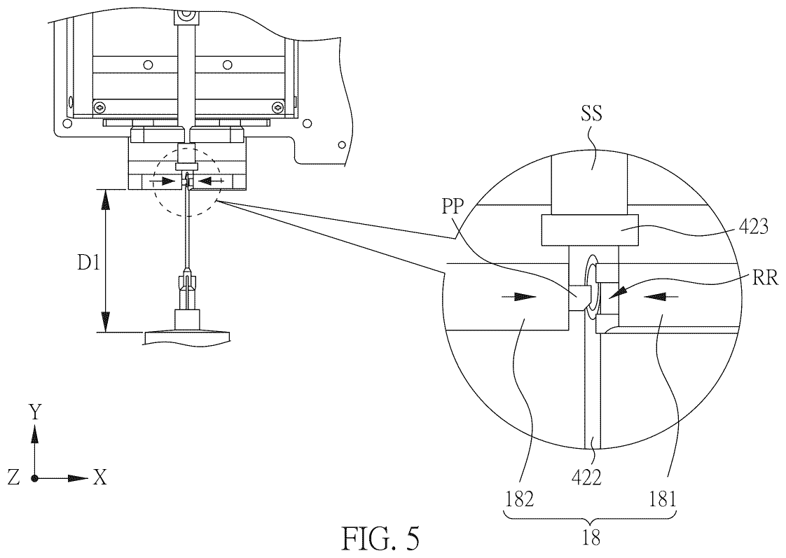

Then, step C2 is executed, in which the needle cover placement and removal device 10 guides and corrects the needle head 422, and the first clamping element 41 continues to clamp and move the syringe 42 without a needle cover so that the needle head 422 begins to be inserted into the needle cover 423. Please refer to FIG. 5 for another schematic diagram of the needle cover placement and removal system according to an embodiment of the present application, in which the dotted frame portion is enlarged for the convenience of explanation. In this step, when the first clamping element 41 and the second clamping element 17 are close to each other so that the needle head 422 is adjacent to the needle cover 423, the adjusting element 18 is provided to adjust the needle head 422 to face the accommodating space SS of the needle cover 423, that is, to cause the first adjusting unit 181 and the second adjusting unit 182 of the adjusting element 18 to be close to each other along the X direction so as to adjust the needle head 422 thereby guiding and correcting the skewed needle head 422, as shown in the enlarged dotted frame portion of FIG. 5. More specifically, in a cross-section of the needle cover placement and removal device 10, the second adjusting unit 182 has a convex portion PP, and the first adjusting unit 181 has a concave portion RR arranged corresponding to the convex portion PP. Therefore, by bringing the first adjusting unit 181 and the second adjusting unit 182 closer to each other, the convex portion PP applies force to the needle head 422 and the corresponding concave portion RR, and thus the skewed needle head 422 may be adjusted. Afterwards, please refer to FIG. 8 for another schematic diagram of the needle cover placement and removal system according to an embodiment of the present application. The first clamping element 41 continues to move upward along the +Y direction to make the first clamping element 41 and the second clamping element 17 continue to be close to each other. The needle head 422 may be adjusted by the adjusting element 18 to face the accommodating space SS and be inserted into the accommodating space SS. That is, the extension direction of the needle head 422 (for example, the Y direction) will be parallel to and face the extension direction of the accommodating space SS (for example, the Y direction). At this moment, the needle head 422 may contact the adjusting element 18 and continue to move, and the distance between the upper edge of the barrel 421 and the adjusting element 18 will be shortened to D2 (D2<D1) to ensure that the needle head 422 is inserted into the accommodating space SS of the needle cover 423. When the needle head 422 has entered the needle cover 423 (for example, but not limited to, more than ½ of the length of the needle head 422 has entered the accommodating space SS of the needle cover 423), the adjusting element 18 may move outward along the X direction to leave the needle head 422. At this moment, the first clamping element 41 may continue to move in the Y direction to complete the cover return operation. At this moment, the distance between the upper edge of the barrel 421 and the adjusting element 18 is the smallest. Specifically, in time sequence, the aforementioned cover return process may be divided into a first time interval and a second time interval later than the first time interval. In the first time interval, the adjusting element 18 contacts the needle head 422, and the needle cover 423 and the needle head 422 partially overlap, while the overlapping portion is gradually increased. In the second time interval, the needle cover 423 and the needle head 422 finally completely overlap, and then the adjusting element 18 may move outward such that the adjusting element 18 is separated from the needle head 422 by a distance greater than 0 so as to leave or not contact the needle head 422.

Then, step C3 is executed, in which the second clamping element 17 of the needle cover placement and removal device 10 opens outward in the X direction to release the needle cover 423, and the first clamping element 41 moves the syringe 42 with the needle cover 423 away from the needle cover placement and removal device 10 along the −Y direction. Thus, the use of the needle cover placement and removal device 10 for cover return can be understood.

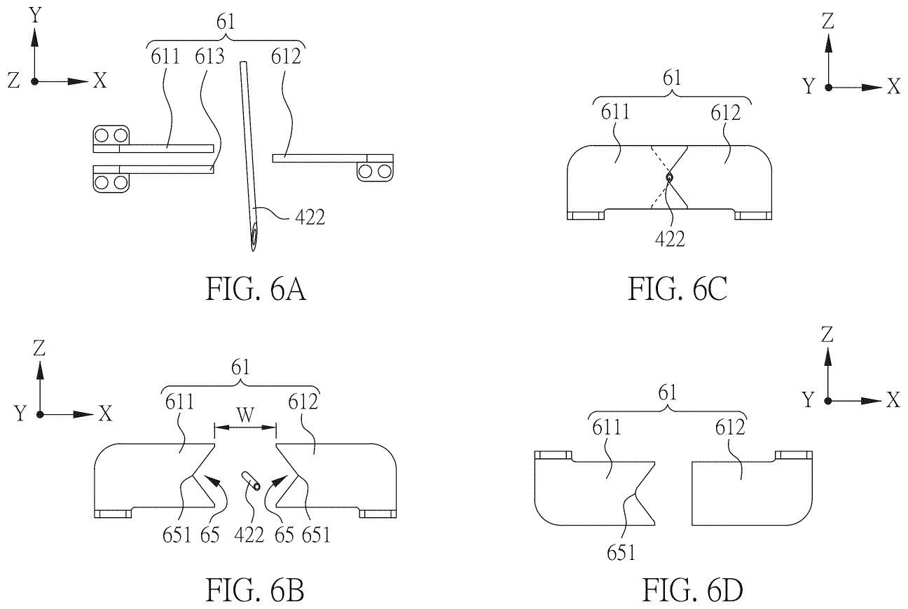

In addition, it should be noted that the aforementioned step C2 for guiding and correcting the needle head 422 is executed by the adjusting element 18, and the adjusting element 18 is a portion of the needle cover placement and removal device 10, but the present application is not limited thereto. In one embodiment of the present application, an independent adjusting device 61 (shown in FIG. 6A and FIG. 6B) may also be provided to guide and correct the needle head 422 of the syringe 42 for cover return, or adjust the needle head 422 of the syringe 42 to be accurately inserted into the insertion hole of the container with the drug solution (not shown). Alternatively, the adjusting device 61 may be used to replace the adjusting element 18 of the needle cover placement and removal device 10 to guide and correct the needle head 422 of the syringe 42 for cover return.

FIG. 6A and FIG. 6B show a side view (Z direction) and a top view (Y direction) of an adjusting device 61 according to an embodiment of the present application, respectively. The adjusting device 61 is suitable for adjusting the needle head 422 of the syringe 42, and includes: a first adjusting unit 611 and a second adjusting unit 612, wherein the first adjusting unit 611 and the second adjusting unit 612 are disposed at different heights in the top-view direction (Y direction), at least one of the first adjusting unit 611 and the second adjusting unit 612 has an opening 65, and the shape of the opening 65 is triangular in the top-view direction (Y direction). In FIG. 6B, it shows that the first adjusting unit 611 and the second adjusting unit 612 each have a triangular opening 65. Accordingly, since the adjusting device 61 adopts a design in which the distance W between the first adjusting unit 611 and the second adjusting unit 612 changes from large to small (that is, gradually decreases), the needle head 422 with different degrees of skewness may be guided and corrected. That is, in the initial state, the syringe 42 is placed in position so that the needle head 422 is between the first adjusting unit 611 and the second adjusting unit 612 (as shown in FIG. 6B) and, at this moment, there is a minimum distance W between the first adjusting unit 611 and the second adjusting unit 612. Then, the second driving unit 16 (shown in FIG. 1, in this embodiment, the adjusting device 61 is used to replace the adjusting element 18) may be used to drive the first adjusting unit 611 and the second adjusting unit 612 to be close to each other and to move toward the center, so that the distance W gradually decreases. Since the first adjusting unit 611 and the second adjusting unit 612 each have a triangular opening 63, when the first adjusting unit 611 and the second adjusting unit 612 are close to each other, in the top-view direction (Y direction), the first adjusting unit 611 and the second adjusting unit 612 will partially overlap, and the area of the opening 65 changes from large to small as the first adjusting unit 611 and the second adjusting unit 612 are close to each other. Therefore, as the first adjusting unit 611 and the second adjusting unit 612 continue to move toward the center, the needle head 422 will be guided to move toward the center at the same time, and finally positioned or engaged at the tip 651 of the two triangular openings 65, as shown in another top view of the adjusting device 61 in FIG. 6C. Accordingly, after the adjusting device 61 is placed in position, the cross design on the left and right sides may guide the needle head 422 to be accurately inserted into the insertion hole of the container (not shown).

In addition, the aforementioned adjusting device 61 may further include a third adjusting unit 613, wherein the first adjusting unit 611, the second adjusting unit 612 and the third adjusting unit 613 may each have a triangular opening 65, and as shown in FIG. 6A, in the top-view direction (Y direction), the second adjusting unit 612 is disposed between the first adjusting unit 611 and the third adjusting unit 613, thereby strengthening the guiding and limiting functions for the needle head 422.

Furthermore, based on the design concept that, when the first adjusting unit 611 and the second adjusting unit 612 are close to each other, the distance W between the two changes from large to small, the shape of one of the first adjusting unit 611 and the second adjusting unit 612 is not limited to the design of using a triangular opening, while a flat design may also be used, and at least one corner of the opening of the other one of the first adjusting unit 611 and the second adjusting unit 612 has an arc shape. FIG. 6D shows a top view (Y direction) of the adjusting device 61 according to another embodiment of the present application, wherein the first adjusting unit 611 has a triangular opening 63 and at least one corner 651 of the triangle has an arc shape, that is, the corner 651 of the triangular opening 63 has an arc shape. However, the second adjusting unit 612 does not have an opening, and is a rectangular design, that is, one side of the second adjusting unit 612 opposite to the triangular opening 63 of the first adjusting unit 611 is in a straight line shape, with which the guiding and/or limiting function of the needle head 422 still may be effectively achieved, so as to reduce the probability that the adjusting device 61 affects the function of the needle head 422 when adjusting the needle head 422 of the syringe 42.

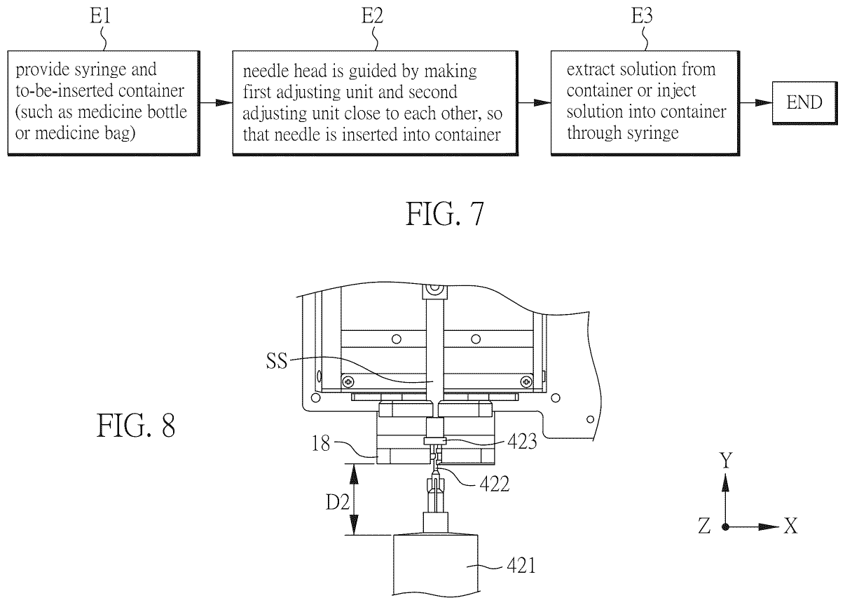

The aforementioned adjusting device 61 may adjust the needle head 422 of the syringe 42 for being accurately inserted into the insertion hole of the container with the drug solution. FIG. 7 shows the operation process of the adjusting device 61, and please refer to FIG. 6A to FIG. 6C at the same time. First, step E1 is executed to provide a syringe 62 and a to-be-inserted container (such as a medicine bottle or a medicine bag). Next, step E2 is executed, in which the needle head 422 is guided by making the first adjusting unit 611 and the second adjusting unit 612 close to each other, so that the needle head 422 may be inserted into the container. Then, step E3 is executed to extract the solution from the container or inject the solution into the container through the syringe 62.

Next, the use of the needle cover placement and removal device 10 in the aforementioned step A3 or step B4 is described. FIG. 3B is a flowchart illustrating the steps of needle cover removal (hereinafter referred to as cover removal) by the needle cover placement and removal system according to an embodiment of the present application, and please refer to FIG. 1 to FIG. 2B at the same time. As shown, at first, step SD1 is executed, in which the first clamping element 41 clamps the syringe 42 with the needle cover 423. Then, step SD2 is executed, in which the needle cover placement and removal device 10 clamps the needle cover 423. Then step SD3 is executed, in which the first clamping element 41 clamps the syringe 42 away from the needle cover placement and removal device 10 to detach the needle head 422 from the needle cover 423. Thus, the use of the needle cover placement and removal device 10 to perform cover removal can be understood.

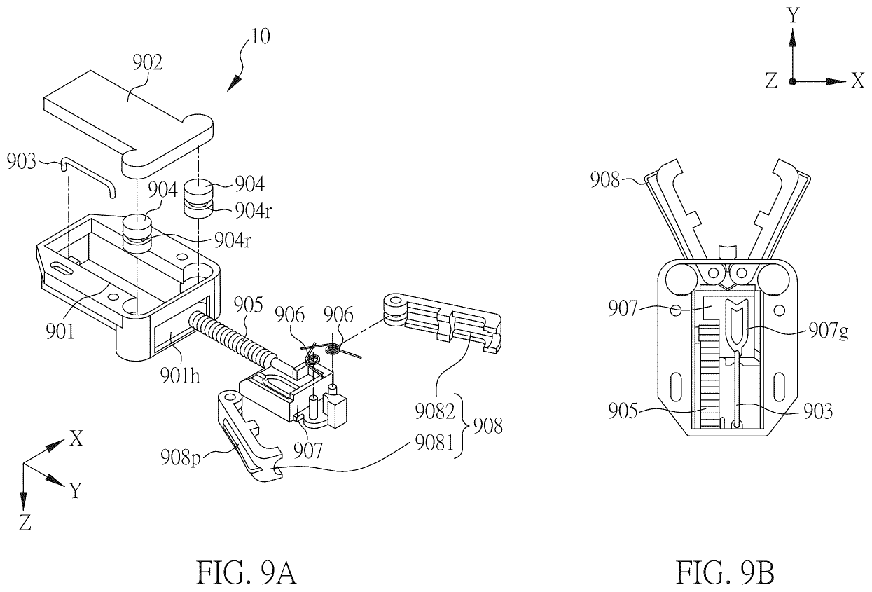

Please refer to FIG. 9A, which is an exploded view of a needle cover placement and removal device 10 for a syringe according to another embodiment of the present application. The needle cover placement and removal device 10 includes a main body 901, a cover 902, a reverse-U shaped cylinder 903, two guide wheels 904, a spring 905, two torsion springs 906, a sliding member 907 and a cover clamping element 908, wherein the reverse-U shaped cylinder 903, the guide wheels 904, the spring 905 and the sliding member 907 are arranged in the space inside the main body 901, and the cover clamping element 908 includes two cover clamping plates 9081, 9082. The cover clamping plates 9081, 9082 each have a protrusion 908p, and the guide wheels 904 each have a groove 904r that may be engaged with the protrusion 908p of the corresponding cover clamping plate 9081, 9082 of the cover clamping element 908. The cover clamping element 908 uses the torsion spring 906 to provide the torque required for clamping the cover and abuts against the spring 905, and is combined with the sliding member 907 through the opening 901h of the main body 901, so that the cover clamping element 908 may clamp the cover inwardly.

FIG. 9B shows the needle cover placement and removal device 10 for a syringe according to another embodiment of the present application in a state where the cover clamping element 908 is open, which shows that there is a groove 907g on the sliding member 907. When the spring 905 is not compressed, one end of the reverse-U shaped cylinder 903 hooks one end of the groove 907g therebelow, so that the cover clamping element 908 is in an open state. Furthermore, when performing cover removal, the needle cover first contacts the sliding member 907 to apply force in the −Y direction, the cover clamping element 908 then clamps the needle cover inwardly by guiding the path of the reverse-U shaped cylinder 903 through the groove 907g, and finally force is applied to the syringe in the +Y direction to complete the cover removal. When cover return is to be performed (the cover clamping element 908 has clamped a needle cover), force is first applied to the syringe in the −Y direction to place the cover, so that the needle cover contacts the sliding member 907 and force is applied in the −Y direction, and then, by guiding the path of the reverse-U shaped cylinder 903 through the groove 907g, the cover clamping element 908 is loosened outwardly to complete the cover return.

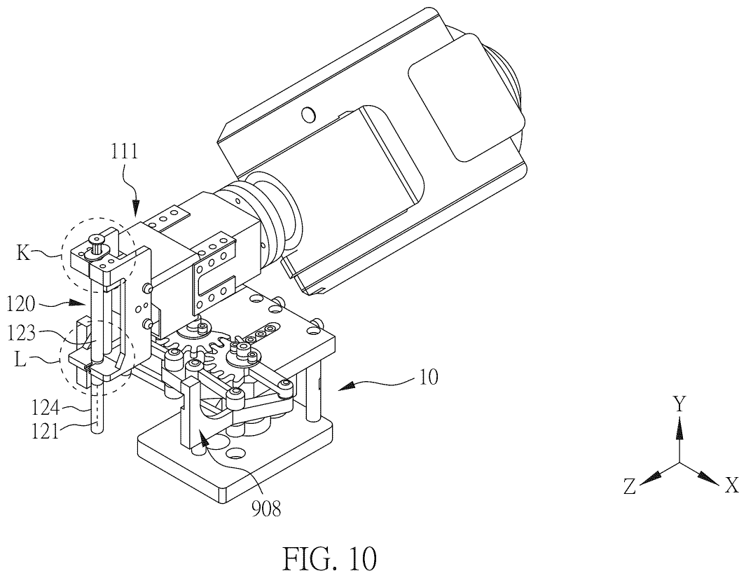

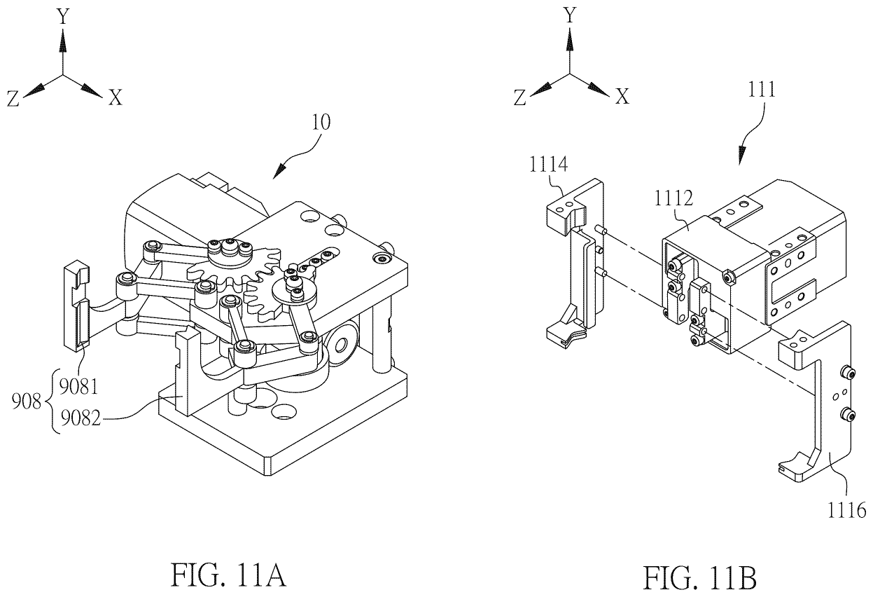

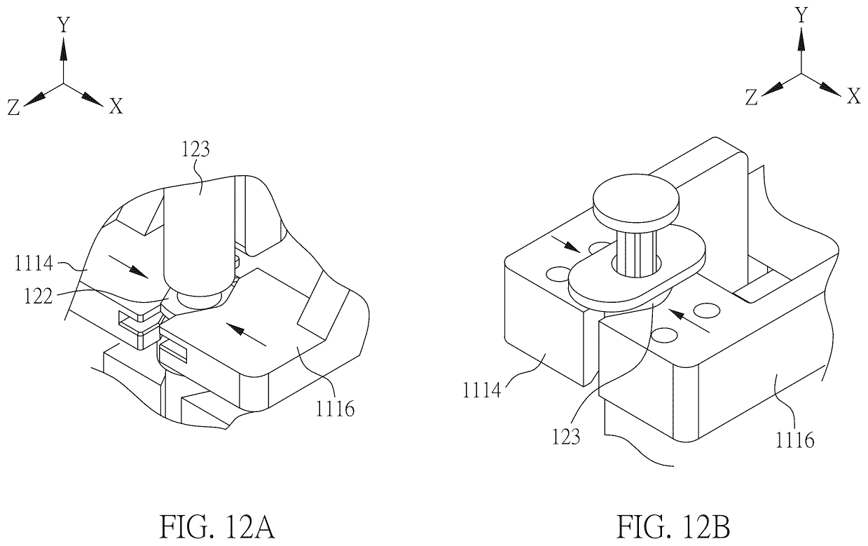

FIG. 10 shows a usage status diagram of a needle cover placement and removal device 10 for a syringe according to another embodiment of the present application, FIG. 11A shows a perspective view of a needle cover placement and removal device 10 for a syringe according to another embodiment of the present application, FIG. 11B shows an exploded view of a clamping device 95 for a syringe according to another embodiment of the present application, FIG. 12A is an enlarged view of the first area L in FIG. 10, and FIG. 12B is an enlarged view of the second area K in FIG. 10. This embodiment is suitable for a syringe 120 with a smaller capacity, for example, one milliliter (1 ml), wherein the 1 ml syringe 120 has a needle handle 122 (shown in FIG. 12A) between the barrel and the needle head.

As shown in FIG. 10, FIG. 11A and FIG. 11B, in this embodiment, the syringe clamping device 111 is responsible for clamping the needle cover 124 of the syringe 120, and the needle cover placement and removal device 10 and the syringe clamping device 111 perform cover return and cover removal operations, which may improve process efficiency. The syringe clamping device 111 includes an electric clamping jaw 1112 and two clamping jaws 1114, 1116. With the driving of the electric clamping jaw 1112, the two clamping jaws 1114, 1116 may clamp the needle base 122 of the syringe 120 (as shown in FIG. 12A) and clamp the barrel 123 of the syringe 120 (as shown in FIG. 12B). Accordingly, when performing cover removal, after the syringe 120 is placed in position, the cover clamping plates 9081, 9082 of the cover clamping element 908 of the needle cover placement and removal device 10 move along the X direction to clamp the needle cover 124, and then the syringe clamping device 111 moves along the Y direction toward the syringe 120. Then, the syringe clamping device 111 is placed in position with the two clamping jaws 1114, 1116 on both sides of the syringe 120. Then, the two clamping claws 1114, 1116 on the syringe clamping device 111 clamp the barrel 123 inwardly along the X direction at a position below the needle handle 122 (as shown in FIG. 10 and FIG. 12A) so as to smoothly remove the cover. Since the needle head 121 and the needle cover 124 of the 1 ml syringe fit tightly together, this embodiment is able to prevent the needle head 121 from being separated from the barrel 123 by clamping the needle handle 122 when the needle cover 124 is separated from the barrel 123. Finally, the syringe clamping device 111 moves toward the +Y direction to complete the cover removal operation. Thus, the use of the needle cover placement and removal device 10 and the syringe clamping device 111 for cover removal may be understood.

When performing cover return, at first, the syringe clamping device 111 clamps the syringe 120 without the needle cover and moves the same in the −Y direction to a cover return position, and then the cover return operation is performed. Then, the needle cover placement and removal device 10 moves in the −X direction so that the needle cover 124 is separated from the needle cover placement and removal device 10, and the syringe clamping device 111 clamps the syringe 120 with the needle cover 124 away from the needle cover placement and removal device 10. Thus, the use of the needle cover placement and removal device 10 and the syringe clamping device 111 for cover return may be understood.

From the above description, it can be seen that, with the design of the structure and method for needle cover placement and removal, the present application is able to achieve automatic cover return and cover removal for the barrel of the syringe, and during the cover return process, the adjusting device is used to adjust and to guide and correct the needle head of the syringe, which may reduce various risks caused by the skewness of the needle head of the syringe and provide a safe and reliable needle cover placement and removal operation.

In one embodiment, it may determine whether a product in contention falls within the protection scope of the present disclosure at least by the presence or absence of components, component configurations and/or operating modes of the product in contention, or by the algorithm of the product in contention, while it is not limited thereto.

The aforementioned specific embodiments should be interpreted as merely illustrative, and not limiting the rest of the present application in any way. cm 1. A needle cover return method for a syringe, comprising:
providing the syringe, wherein the syringe is fixed on a first clamping element and has a needle head;
providing a needle cover, wherein the needle cover is fixed on a second clamping element and has an accommodating space;
providing an adjusting element, wherein, when the first clamping element and the second clamping element are close to each other so that the needle head is adjacent to the needle cover, the adjusting element is provided to adjust an extension direction of the needle head to be toward an extension direction of the accommodating space; and
the first clamping element and the second clamping element continuing to be close to each other so that the needle head is inserted into the accommodating space of the needle cover.

2. The needle cover return method as claimed in claim 1, wherein the extension direction of the accommodating space is parallel to the extension direction of the needle head.

3. The needle cover return method as claimed in claim 1, further comprising:
providing a limiting element, wherein the limiting element is provided to contact the needle cover.

4. The needle cover return method as claimed in claim 1, wherein the adjusting element includes a first adjusting unit and a second adjusting unit, and the extension direction of the needle head is adjusted by controlling the first adjusting unit and the second adjusting unit to be close to each other.

5. A needle cover placement and removal system for returning a needle cover to a syringe, comprising:
a first clamping element for fixing the syringe, wherein the syringe has a needle head;
a second clamping element for fixing the needle cover, wherein the needle cover has an accommodating space; and
an adjusting element, wherein, when the first clamping element and the second clamping element continue to be close to each other, the adjusting element is provided to adjust an extension direction of the needle head toward an extension direction of the accommodating space.

6. The needle cover placement and removal system as claimed in claim 5, wherein a period during which the needle cover is returned to the syringe is divided into a first time interval and a second time interval later than the first time interval, the adjusting element contacts the needle head and the needle cover and the needle head partially overlap in the first time interval, and the needle cover and the needle head completely overlap in the second time interval.

7. The needle cover placement and removal system as claimed in claim 6, wherein, in the second time interval, the adjusting element is separated from the needle head by a distance greater than zero.

8. The needle cover placement and removal system as claimed in claim 5, further comprising a limiting element, wherein the limiting element is provided to contact the needle cover.

9. The needle cover placement and removal system as claimed in claim 5, wherein the adjusting element includes a first adjusting unit and a second adjusting unit, and the first adjusting unit and the second adjusting unit are close to each other to adjust the extension direction of the needle head.

10. The needle cover placement and removal system as claimed in claim 9, wherein at least one of the first adjusting unit and the second adjusting unit has an opening, and a shape of the opening is a triangle in a top-view direction.

11. An adjusting device for adjusting a needle head of a syringe, comprising:
a first adjusting unit; and
a second adjusting unit,
wherein at least one of the first adjusting unit and the second adjusting unit has an opening, and a shape of the opening is a triangle in a top-view direction.

12. The adjusting device as claimed in claim 11, further comprising a driving unit, wherein the driving unit drives the first adjusting unit and the second adjusting unit to be close to each other.

13. The adjusting device as claimed in claim 12, wherein, when the first adjusting unit and the second adjusting unit are close to each other, the first adjusting unit and the second adjusting unit partially overlap in the top-view direction.

14. The adjusting device as claimed in claim 11, further comprising a third adjusting unit, wherein, in the top-view direction, the second adjusting unit is disposed between the first adjusting unit and the third adjusting unit.

15. The adjusting device as claimed in claim 11, wherein at least one corner of the opening has an arc shape.

16. The adjusting device as claimed in claim 11, wherein the first adjusting unit and the second adjusting unit are disposed at different heights in the top-view direction.

17. The adjusting device as claimed in claim 11, wherein, when the first adjusting unit and the second adjusting unit are close to each other, an area of the opening changes from large to small in the top-view direction.

18. The adjusting device as claimed in claim 11, wherein each of the first adjusting unit and the second adjusting unit has a triangular opening.

19. The adjusting device as claimed in claim 14, wherein each of the first adjusting unit, the second adjusting unit and the third adjusting unit has a triangular opening.

20. The adjusting device as claimed in claim 11, wherein the first adjusting unit has a triangular opening, and one side of the second adjusting unit opposite to the triangular opening of the first adjusting unit is in a straight line shape.
